(19) United States
(12) Patent Application Publication
(10) Pub. No.: US 2006/0204243 A1
(43) Pub. Date: Sep. 14, 2006

(54) LENS MODULE FOR A DIGITAL CAMERA

(75) Inventor: KUN-JUNG TSAI, TUCHENG (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/307,794

(22) Filed: Feb. 22, 2006

(30) Foreign Application Priority Data
Mar. 11, 2005 (CN) 200510033618.9

(51) Int. Cl. G03B 17/00

(52) U.S. Cl. 396/529

(57) ABSTRACT

A lens module (20) is adapted for use in a digital camera. A lens module includes a lens barrel (21), a plurality of lenses including a first lens (22) and a second lens (23) and an aligning mechanism. The two lenses received in the lens barrel. The aligning mechanism an aligning mechanism configured to align respective optical axes of the first and second lenses with each othe. The aligning mechanism is disposed between the two lenses.

### FIELD OF THE INVENTION

The present invention relates generally to lens modules, and, more particularly, to a lens module for a digital camera.

### DESCRIPTION OF RELATED ART

Currently, digital camera modules are in widespread use in a variety of portable electronic devices. Most portable electronic devices are becoming progressively more miniaturized over time, and digital camera modules are correspondingly becoming smaller and smaller. For example, digital camera modules are now widely available as a feature of a mobile phone. Nevertheless, in spite of the small size of a contemporary digital camera module, consumers still demand excellent imaging. The quality of the image provided is mainly dependent upon the optical elements of the digital camera module.

Referring to FIG. 4, a contemporary lens module 10 for a digital camera generally includes a lens barrel 11, a plurality of lenses 12, 13, a plurality of spacers 14, 15, and an IR-cut filter 16. The lens barrel 11 is a hollow cylinder for receiving the lenses 12, 13, the spacers 14, 15, and the IR-cut filter 16 therein. The spacers 14, 15 are annular shaped. In assembly, the lenses 12, 13 and the spacers 14, 15 are arranged in the lens barrel 11 in an alternating fashion. The lenses 12, 13 are adhered to the inside of the lens barrel 11. Each spacer has a thickness that defines a desired distance between the lenses 12, 13. The IR-cut filer 16 is disposed at the bottom of the lens barrel. The optical axes of the lenses 12, 13 are aligned by means of a round tolerance of the inner wall of the lens barrel 11 and configuration of the spacers 14, 15.

However, because different plastics have about a 0.5 percent to 0.6 percent contraction factor during the injection molding process, precisely matching the inner diameter of the lens barrel 11 to provide the greatest effect for optical axes alignment is difficult. Further, the round tolerance of the lens barrel 11 may not meet a desired requirement or the axis of the lens barrel 11 may not be able to be aligned with the optical axis of the lenses 12, 13. Although spacers 14, 15 are adopted, they do not overcome the above-mentioned deficiencies. Furthermore, though alignment may be obtained initially this can be lost over time due to the imprecise assembly. That is, the optical axes of the plurality of lenses 12, 13 may become misaligned.

What is needed, therefore, is a lens module for a digital camera, which satisfies the needs for convenient assembly and accurate, long lasting alignment of optical axes of lenses.

### SUMMARY OF INVENTION

A lens module is adapted for use in a digital camera. The lens module includes a lens barrel, two lenses and an aligning mechanism. The two lenses received in the lens barrel. The aligning mechanism is adapted to align optical axes of the two lenses, and is disposed between the two lenses.

Other advantages and novel features will become more apparent from the following detailed description when taken in conjunction with the accompanying drawings.

### BRIEF DESCRIPTION OF DRAWINGS

Many aspects of the lens module can be better understood with reference to the following drawings. The components in the drawings are not necessarily to scale, the emphasis instead being placed upon clearly illustrating the principles of the present lens module. Moreover, in the drawings, like reference numerals designate corresponding parts throughout the several views.

FIG. 1 is a schematic view of a lens module for a digital camera, in accordance with a first preferred embodiment, the lens module including lenses;

FIG. 2 is a schematic view of the lenses of FIG. 1;

FIG. 3 is a schematic view of a lens module for a digital camera, in accordance with a second preferred embodiment; and

FIG. 4 is a schematic view of a conventional lens module for a digital camera.

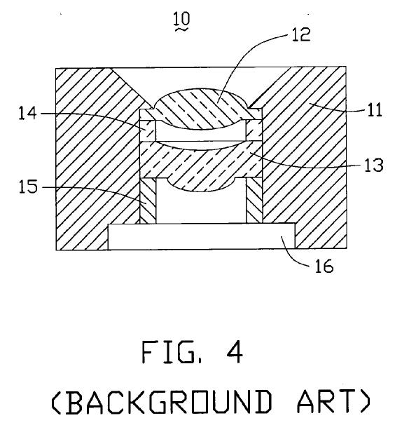

### DETAILED DESCRIPTION

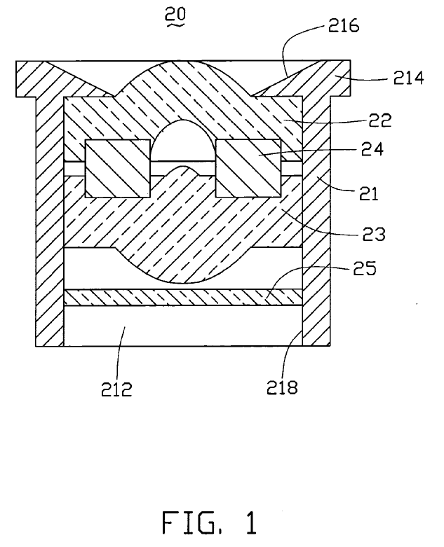

Referring now to the drawings, FIG. 1 shows a lens module 20 for a digital camera, according to a first preferred embodiment. The lens module 20 is adapted for use in digital cameras used in portable electronic devices such as a mobile phones or Personal Digital Assistants (PDAs), but the compact nature thereof could prove useful in compact digital camera units or digital camcorders, as well. The lens module 20 includes a lens barrel 21, a first lens 22, a second lens 23, a spacer 24 functioning as an aligning mechanism, and an IR-cut filter 25. The first lens 22, the spacer 24, the second lens 23, and the IR-cut filter 25 are received in the lens barrel 21 in that order.

The lens barrel 21 is a hollow cylinder with an open end 212 and a half-closed (i.e., partially-closed) end 214. The lens barrel 21 defines a cone-shaped hole 216 in the center of the half-closed end 214 so that light beams can be transmitted therethrough.

The first lens 22 and the second lens 23 are both used to focus the incident light. The first lens 22 and the second lens 23 are circular. The outer diameters of the first lens 22 and the second lens 23 correspond to the inner diameter of the lens barrel 21.

The first lens 22 has an outer peripheral surface 221, a top mounting surface 223, and a bottom mounting surface 224. The first lens 22 has a meniscus central portion, which defines two opposite top and bottom aspheric surfaces (not shown) respectively. The bottom aspheric surface of the first lens 22 is concave. The first lens 22 has an annular groove 225 defined in the bottom mounting surface 224, by a groove peripheral surface 226 and a groove bottom surface 227.

The second lens 23 has an outer peripheral surface 231, a top mounting surface 233 and a bottom mounting surface 234. The second lens 23 has a central portion, which defines two opposite top and bottom aspheric surfaces (not shown) respectively. The top and bottom aspheric surfaces protrude outwardly. The second lens 23 has an annular groove 235 defined in the top mounting surface 233, by a groove peripheral surface 236 and a groove bottom surface 237. The optical axis of the annular groove 225 of the first lens 22 and the annular groove 235 of the second lens 23 are aligned with the optical axis of the first lens 22 and the second lens 23. An outer diameter of the annular groove 225 of the first lens 22 is same as that of the annular groove 235 of the second lens 23.

The spacer 24 is annular shaped , and received in the lens barrel 21. The spacer 24 is disposed between the first lens 22 and the second lens 23. An outer diameter of the spacer 24 is same as or slightly greater than an outer diameter of the annular grooves 225, 235, and an inner diameter of the spacer 24 is equal to or slightly smaller than an inner diameter of the annular grooves 225, 235. One surface of the spacer 24 resists the bottom surface 227 of the annular groove 225 of the first lens 22, an opposite surface of the spacer 24 resists the bottom surface 237 of the annular groove 235 of the second lens 23.

The IR-cut filter 25 can prevent incident infrared light rays from reaching an image pick-up sensor in the digital camera. The IR-cut filter 25 is received in the bottom of the lens barrel 21.

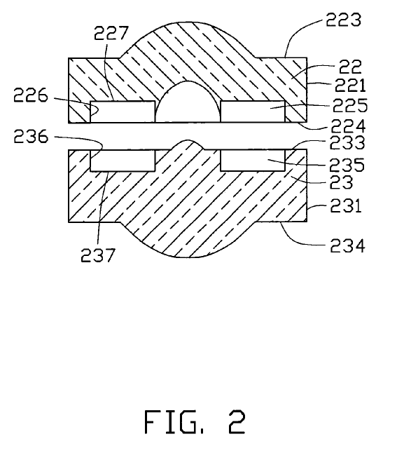

Referring now to FIG. 2, in assembling the lens module 20, the first lens 22 is inserted into the lens barrel 21 via the open end 212 of the lens barrel 21. The outer peripheral surface 221 tightly engages with an inner peripheral surface 218 of the lens barrel 21. Then, the spacer 24 is received into the lens barrel 21 via the open end 212 of the lens barrel 21, and inserted into the annular groove 225 of the first lens 22. An outer peripheral surface of the spacer 24 tightly engages with the inner peripheral surface 226 of the first lens 22, and supports the first lens 22. The second lens 23 is placed in the lens barrel 21 fitting against and receiving the spacer 23 into the annular groove 235 of the second lens 23. The outer peripheral surface of the spacer 24 also tightly engages with the inner peripheral surface 236 of the second lens 23. Lastly, the IR-cut filter 25 is received in the lens barrel 21, and an outer peripheral surface of the IR-cut filter 25 tightly engages with the inner peripheral surface 218 of the lens barrel 21.

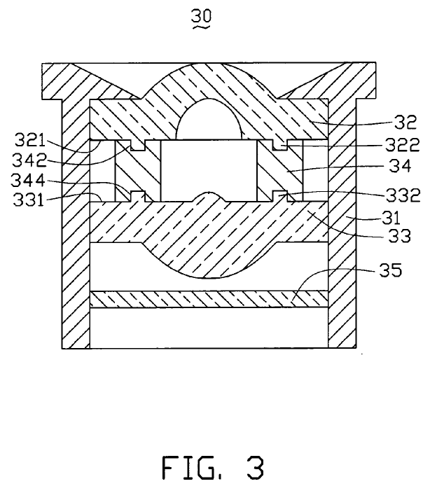

Referring to FIG. 3, a lens module 30 according to a second preferred embodiment of the present invention is shown. The lens module 30 includes a lens barrel 31, a first lens 32, a second lens 33, a spacer 34, and an IR-cut filter 35. In this embodiment, the lens barrel 31, and the IR-cut filter 35 are same as the lens barrel 21 and the IR-cut filter 25 in the first embodiment. The first lens 32 has a first annular protrusion 322 in a bottom mounting surface 321 thereof. The second lens 33 has a second annular protrusion 332 in a top mounting surface 331 facing the bottom mounting surface 321 of the first lens 32. The spacer 34 has two annular grooves 342, 344 respectively defined in two surfaces thereof, corresponding to the annular protrusions 322, 332. In assembly, the annular protrusions 322, 332 of the first lens 32, and the second lens 33 are respectively inserted into the annular grooves 342, 344 of the spacer 34 to achieve the alignment of the optical axes of the first lens 32 and the second lens 33.

Additionally, an AR-Coating (anti-reflective coating) can be provided on at least one of the aspheric surfaces of the first lens 222. The AR-Coating is typically a thin film that includes alternately stacked layers of silicon dioxide (SiO2) and tantalum pentoxide (Ta2O5). Therefore, the light transmittance ratio of the first lens 22 is increased, and the reflectivity of the first lens 22 is decreased. Furthermore, the IR-cut filter 25 can be omitted, and an IR-Cut coating can be provided on at least one of the aspheric surfaces of the second lens 23. The spacer 24 can be other orientation means.

In alternative embodiments, the number of the lens in the lens barrel can be three or more. Also, the number of the spacer 23 can be two or more dependent on the number of the lens.

Compared with other lens modules, the spacer 24 does not directly contact with the lens barrel 21. Thus, the round tolerance of the lens barrel 21 has nothing with the spacer 24. Therefore, the optical axes of the first lens 22 and the second lens 23 are reliably aligned to a greater accuracy since a spacer 24 is adopted to determine not only the alignment of optical axes of the lenses 22, 23, but also orientation of the first lens 22 and the second lens 23. Accordingly, an image quality of the digital camera with the lens module is increased.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A lens module comprising:
a lens barrel;
a plurality of lenses including a first lens and a second lens, each lens being received in the lens barrel; and
an aligning mechanism configured to align respective optical axes of the first and second lenses with each other, the aligning mechanism disposed between the two lenses.

2. The lens module as claimed in claim 1, wherein the first lens has a first lens surface facing a second lens surface of the second lens, the first lens surface and the second lens surface having formed therein, respectively, a first annular groove and a second annular groove, the aligning mechanism includes the first annular groove, the second annular groove, and an orientation means, the orientation means being disposed between the two lenses and engaging in the annular grooves.

3. The lens module as claimed in claim 2, wherein the orientation means comprises a spacer.

4. The lens module as claimed in claim 3, wherein the spacer separates from the lens barrel.

5. The lens module as claimed in claim 3, wherein the spacer is annular shaped, an outer diameter of the spacer is equal to or slightly greater than an outer diameter of corresponding annular grooves, and an inner diameter of the spacer is equal to or slightly smaller than an inner diameter of a corresponding annular groove.

6. The lens module as claimed in claim 1, wherein the first lens has a first lens surface facing a second lens surface of the second lens, the first lens surface and the second lens surface having formed thereon, respectively, a first annular protrusion and a second annular protrusion, the aligning mechanism includes the first annular protrusion, the second annular protrusion, and an orientation means, the orientation means is disposed between the two lenses and engaging with the first and second annular protrusions.

7. The lens module as claimed in claim 6, wherein the orientation means is a spacer, the spacer has two annular grooves respectively defined in two surfaces thereof, corresponding to the annular protrusions.

8. The lens module as claimed in claim 7, wherein the spacer separates from the lens barrel.

9. The lens module as claimed in claim 1, wherein the lens barrel has an open end and a half-closed end.

10. A lens module comprising:
a lens barrel;
a plurality of lenses received in the lens barrel; and
a plurality of aligning mechanisms configured to align optical axes of the plurality of lenses with each other, each aligning mechanism disposed between each corresponding two lenses.

11. The lens module as claimed in claim 10, wherein the first lens has a first lens surface facing a second lens surface of the second lens, the first lens surface and the second lens surface having formed therein, respectively, a first annular groove and a second annular groove, the aligning mechanism includes the first annular groove, the second annular groove, and an orientation means, the orientation means being disposed between the two lenses and engaging in the annular grooves.

12. The lens module as claimed in claim 11, wherein the orientation means comprises a spacer.

13. The lens module as claimed in claim 12, wherein the spacer separates from the lens barrel.

14. A lens module comprising:
a lens barrel;
a plurality of lenses including a first lens and a second lens, each lens being received in the lens barrel; and
an aligning mechanism respectively fixed with the first and second lenses radially and axially such that the optical axes of the first and second lenses align with each other.

15. The lens module as claimed in claim 14, wherein the first lens has a first lens surface facing a second lens surface of the second lens, the first lens surface and the second lens surface having formed therein, respectively, a first annular groove and a second annular groove, the aligning mechanism includes the first annular groove, the second annular groove, and an orientation means, the orientation means being disposed between the two lenses and engaging in the annular grooves.

16. The lens module as claimed in claim 15, wherein the orientation means comprises a spacer.

17. The lens module as claimed in claim 17, wherein the orientation means comprises a spacer.

18. The lens module as claimed in claim 14, wherein the first lens has a first lens surface facing a second lens surface of the second lens, the first lens surface and the second lens surface having formed thereon, respectively, a first annular protrusion and a second annular protrusion, the aligning mechanism includes the first annular protrusion, the second annular protrusion, and an orientation means, the orientation means is disposed between the two lenses and engages with the first and second annular protrusions.

19. The lens module as claimed in claim 18, wherein the orientation means is a spacer, the spacer has two annular grooves respectively defined in two surfaces thereof, engagingly receiving the annular protrusions.
